(19) United States
(12) Patent Application Publication
(10) Pub. No.: US 2025/0344121 A1
(43) Pub. Date: Nov. 6, 2025

(54) PCELL RADIO LINK FAILURE FAST RECOVERY

(71) Applicant: Lockheed Martin Corporation, Bethesda, MD (US)

(72) Inventor: Liwa Wang, Morris Plains, NJ (US)

(21) Appl. No.: 18/655,812

(22) Filed: May 6, 2024

(51) Int. Cl. H04W 36/18; H04W 36/00; H04W 36/08; H04W 76/20

(52) U.S. Cl. CPC H04W 36/18; H04W 36/0079; H04W 36/08; H04W 76/20

(57) ABSTRACT

In an embodiment, a base station establishes the first radio link between a first cell and a user device and then configures the first cell as a primary cell and the first radio link as a primary radio link. The base station also establishes two or more secondary radio links between the user device and the secondary cells selected from a plurality of cells that are able to communicate with the user device. One of the secondary cells is then selected and configured to be a special secondary cell. When the base station receives an indication that the primary radio link has failed from the special secondary cell, the base station uses the special secondary cell to forward a reconfiguration message to the user device and a handover of the primary radio link from the first cell to a new primary cell may be performed to avoid radio link reestablishment.

### TECHNICAL FIELD

The present disclosure generally relates to cellular networks and, more particularly, to a method and apparatus for PCell radio link failure fast recovery.

### BACKGROUND

Cellular networks are increasingly relied on to provide data and voice services to a variety of devices. As the devices continue to demand more data at a faster rate, various techniques have been developed to provide an increased data rate. One such method is carrier aggregation, when a user device, such as a smartphone, is connected to more than one cell.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems and components depicted in the accompanying figures are not to scale, and components within the figures may be depicted not to scale with each other.

FIGS. 1A and 1B illustrate a cellular system utilizing carrier aggregation in accordance with at least one embodiment.

FIG. 2 illustrates signaling between a base station, multiple cells, and user equipment in accordance with at least one embodiment.

FIG. 3 illustrates a signaling diagram for performing PCell radio link failure fast recovery in accordance with at least one embodiment.

FIG. 4 illustrates a flow diagram of a method for performing PCell radio link failure fast recovery in accordance with at least one embodiment.

FIG. 5 illustrates a computer architecture diagram shown in an illustrative computer hardware architecture in accordance with at least one embodiment.

### DESCRIPTION OF EXAMPLE EMBODIMENTS

### Overview

According to an embodiment, the disclosure describes a method for performing PCell radio link failure fast recovery. The method is used in carrier aggregation to establish a connection between a user device or equipment (UE) and a base station, such as but not limited to a next-generation or generalized NodeB (GNB). The base station, or GNB, communicates with the UE through multiple cells, including a primary cell (PCell) and one or more secondary cells (SCells). In this method, at least one of the SCells is configured as a special SCell (SPSCell). When the PCell fails, the SPSCell is used to communicate with the UE to perform a handover from the failed PCell to a new PCell.

According to another embodiment, the disclosure describes a computer-implemented method. The method includes establishing a first radio link between a first cell and a user device and configuring the first cell as a primary cell and the first radio link as a primary radio link. The method then establishes a secondary radio link with each of two or more secondary cells selected from a plurality of additional cells that are able to communicate with the user device. A second cell is selected and configured from the two or more secondary cells to be a special secondary cell. Once the second cell is configured as a special secondary cell, it is able to receive a radio frequency (RF) failed indication for the primary radio link. The method then is also able to send a radio resource control (RRC) reconfiguration message through the special secondary cell to the user device and perform a handover. The handover moves the primary radio link from the first cell that is RF failed to a new primary cell selected from one of the plurality of additional cells that are able to communicate with the user device.

According to yet another embodiment, the disclosure describes a base station. The base station comprises one or more processors and one or more computer-readable non-transitory storage media coupled to one or more processors that store instructions operable when executed by one or more processors to perform operations. The operations include establishing a first radio link between a first cell and a user device and configuring the first cell as a primary cell and the first radio link as a primary radio link. The operations then establish a secondary radio link with each of two or more secondary cells selected from a plurality of additional cells that are able to communicate with the user device. A second cell is selected and configured from the two or more secondary cells to be a special secondary cell. Once the second cell is configured as a special secondary cell, it is able to receive an indication that the primary radio link has failed. The operations then are also able to send an RRC reconfiguration message through the special secondary cell to the user device and perform a handover. The handover moves the primary radio link from the first cell that is RF failed to a new primary cell selected from one of the plurality of additional cells that are able to communicate with the user device.

According to yet another embodiment, the disclosure describes one or more computer-readable non-transitory storage media embodying instructions that, when executed by a processor, cause the processor to perform operations. The operations include establishing a first radio link between a first cell and a user device and configuring the first cell as a primary cell and the first radio link as a primary radio link. The operations then establish a secondary radio link with each of two or more secondary cells selected from a plurality of additional cells that are able to communicate with the user device. A second cell is selected and configured from the two or more secondary cells to be a special secondary cell. Once the second cell is configured as a special secondary cell, it is able to receive an indication that the primary radio link has failed. The operations then are also able to send an RRC reconfiguration message through the special secondary cell to the user device and perform a handover. The handover moves the primary radio link from the first cell that is RF failed to a new primary cell selected from one of the plurality of additional cells that are able to communicate with the user device.

Technical advantages of certain embodiments of this disclosure may include one or more of the following. Certain systems and methods described herein may allow for performing handover instead of reestablishment when a PCell RF fails. This allows for less data loss due to the RF failure of the PCell and maintains the link with the SCells. This will result in increased reliability for the UE communicating with the GNB and also an improved data rate.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

The present disclosure describes an approach that allows for performing a handover instead of reestablishment when a PCell fails when carrier aggregation is configured. At least one of the SCells connected to the UE is configured as an SPSCell. This SPSCell is able to receive a radio link failure (RLF) message from the UE when the PCell fails. The RLF failure message in one or more embodiments includes additional information, including at least the measurements of neighbor cells. Using this RLF message, a new PCell may be selected, and handover may occur with little or no interruption from the UE's perspective.

Carrier aggregation is a technique used in fourth-generation (4G), such as long-term evolution (LTE) and fifth-generation (5G or NR) cellular systems. In carrier aggregation, multiple frequency blocks or carriers are assigned to the same UE, which allows for an increased data rate between the UE, the GNB, and the backend network. Frequently, these carriers are provided by a plurality of cells that may be co-located and served by at least one macro or PCell and a plurality of SCells.

A PCell provides the radio resource control (RRC) connection between the UE and the GNB, whereas typically, the SCells do not provide RRC connections, either due to not being configured to be able to provide RRC connections or due to data rate efficiencies when communicating with the UE using carrier aggregation. When the PCell experiences RLF, the RRC connection is lost. RLF occurs, for example, when high interference is present, the UE moves to a location where the PCell lacks coverage or for other reasons. If no additional means are provided, when RLF occurs, the GNB has to initiate a reestablishment procedure to reestablish a connection with the UE. During the reestablishment procedure, cached data in the PCell may be purged, and the connection with any SCells may also be terminated. The UE may then need to connect to a new PCell and reconnect to any SCells if it is determined that carrier aggregation should continue.

To overcome these problems, in one or more embodiments of the disclosure, at least one of the SCells is selected as an SPSCell to also provide an RRC connection. This RRC connection for the SPSCell may serve as a secondary or backup RRC connection, and the RRC connection may provide backup and/or additional physical downlink control channel (PDCCH) and physical uplink control channel (PUCCH) connections between the UE and the GNB. When RLF occurs for the PCell, this secondary RRC is then used to forward a FailureInformation message to the GNB. The UE uses the FailureInformation message to signal that it is or is about to be in RLF with the PCell. The FailureInformation message is modified in one or more embodiments to include the available measurement of all or most of the neighboring cells the UE is able to connect to or at least receive enough signal to make a measurement. The GNB is able to select a new cell using that measurement data, and a handover may occur, establishing a new PCell.

The various aspects may be implemented in many different forms and should not be construed as limited to the implementations set forth herein. The disclosure encompasses variations of the embodiments as described herein. Like numbers refer to like elements throughout.

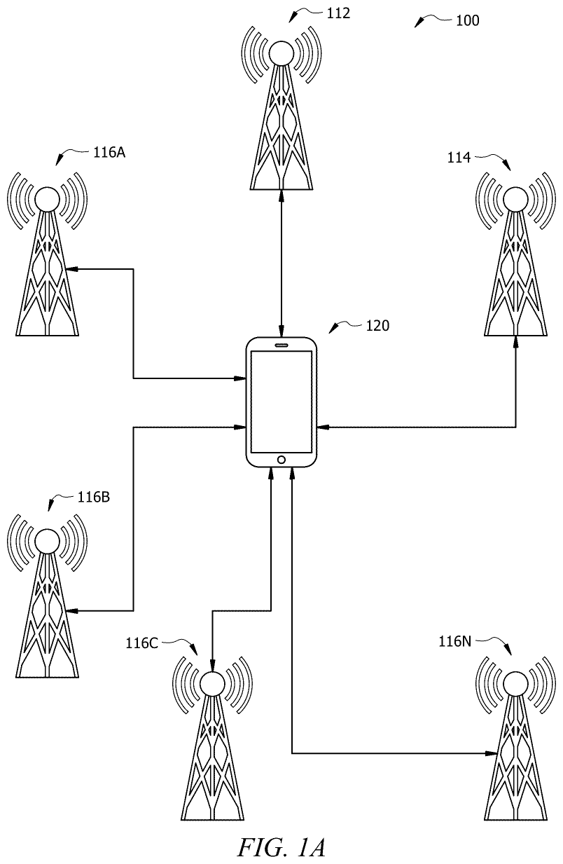

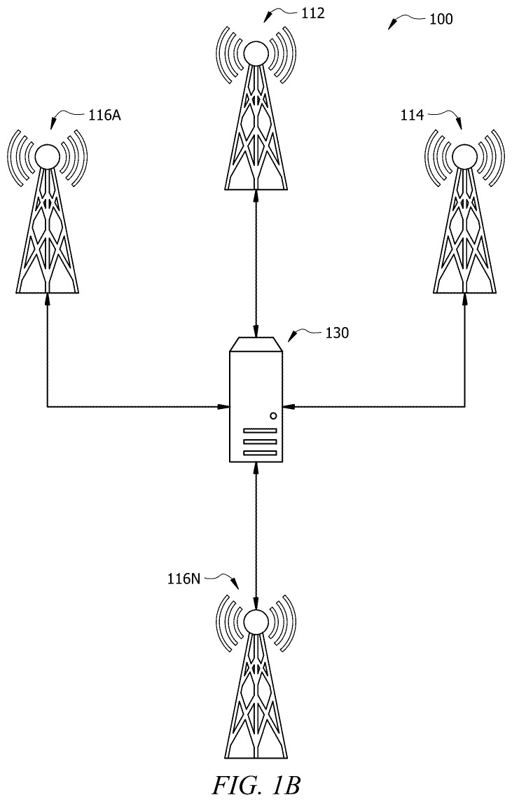

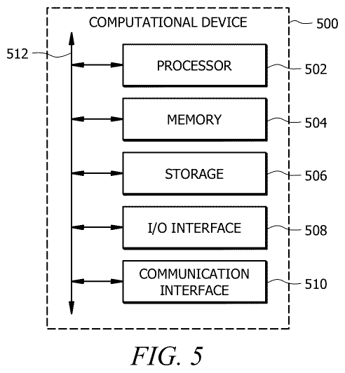

FIGS. 1A and 1B illustrate a diagram of an example system 100, which performs PCell radio link failure fast recovery when a UE 120 is connected to a base station 130 using a plurality of cells 112, 114, and 116A-116N configured for carrier aggregation. Cells 112, 114, and 116A-116N may serve as PCells, SPSCells, SCells, and/or neighboring cells that are able to connect to the UE. The base station 130 may be a GNB or may take the form of an enhanced node B (ENB) or any other generation or configuration of the base station 130. The system 100 may include more or fewer devices than that shown in FIGS. 1A and 1B. Each component may be a separate physical device, and/or one or more may be implemented using the same physical device or at the same location. Each component may also be implemented by a computational or radio device configured to execute one or more stored instructions, such as those described in FIG. 5.

The system 100 may include one or more user devices, such as UE 120. The UE 120 may be any computational device that connects to the cellular network through at least a PCell 112 or another cell, e.g., 116A, and a base station 130. The UE 120 may take the form of tablets, smartphones, sensors, computational devices on automobiles, and/or other computational devices or devices incorporating a computational device. The UE 120 may take any form configured to execute one or more stored instructions. In one or more embodiments, the UE 120 may be in the form of the computational device 500 described in FIG. 5.

The UE 120 contains at least one transceiver and cellular modem, among other things. These components allow the UE 120 to communicate through an antenna with one or more antennas associated with the base station 130. The UE 120 may communicate data and/or voice with a network such as the Internet through the base station 130. The UE 120 may also receive and/or transmit various control messages, signaling messages, status messages, measurement messages, and other messages as needed to the base station 130 and/or the cells, e.g., 116A. In one or more embodiments, this may include RRC-related messages and a FailureInformation message, RRCReconfiguration, and/or messages related to a reestablishment procedure. The disclosure is not limited to the above-mentioned messages, and more or fewer messages may be sent and/or received by the UE 120 without departing from the disclosure.

The UE 120 communicates to the base station 130 through one or more cells, e.g., 112 and 116A. The base station 130 may take the form of a GNB, an ENB, or any other form that is able to support carrier aggregation. The base station 130 provides a connection between the UE 120 and the wider underlying network(s). The base station 130 may include RF power amplifiers, signal processors, computational devices, and other devices for connecting to the underlying network(s) and facilitating communication with the UE 120. The base station 130 may take any form configured to execute one or more stored instructions. In one or more embodiments, the base station 130 may be in the form of the computational device 500 described in FIG. 5

The base station 130 may include one or more antennas supporting one or more cells, e.g., 116A. As will be described below, one or more cells, e.g., 112 and 116A, may be co-located with the base station 130, or one or more may be located at another geographic location. For example, the base station 130 may include a PCell 112 configured as a macro cell, while other cells, such as some of the SCells, e.g., 116A-116N, may be located at different physical locations and/or take the form of micro or pico cells.

The UE 120 is often able to communicate with the base station 130 through multiple cells, e.g., 112 and 116A. Initially, the UE 120 will communicate with a PCell 112. The PCell 112 allows the UE 120 to communicate with the base station 130. The PCell 112 may communicate with the UE 120 alone, or it may, for example, during carrier aggregation, communicate along with an additional cell 116A or 114 and/or a plurality of other cells 116A-116N that are able to communicate with the UE 120.

The PCell 112 and/or other cells 116A-116N may communicate using such technology as orthogonal frequency-division multiplexing (OFDM), frequency-division duplex (FDD), time-division duplex (TDD), multiple input and multiple output (MIMO), as well as other technologies and protocols. The PCell 112 and/or other cells 116A-116N may operate using 5G NR technology, and/or one or more of the cells 116A-116N may operate using 4G or LTE technologies such as evolved universal terrestrial radio access (EUTRA) and/or universal terrestrial radio access (UTRA).

In one or more embodiments, the base station 130 may configure the system 100 to operate in carrier aggregation. When this is done, one or more additional cells 116A-116N may be configured as SCells. SCells work with the PCell to provide increased data transmission, bandwidth, and/or bit rate. When carrier aggregation is configured, each carrier has a separate cell configured for it, with the PCell providing RRC and other information such as security parameters and system information. The secondary cells may only provide user data. While each base station 130 may be connected to a plurality of cells 116N, the number of secondary cells that may be connected to the UE 120 at any time may be based on the location of the UE, interference, the specific needs of the UE and standards for 4G and 5G cellular networks as appropriate.

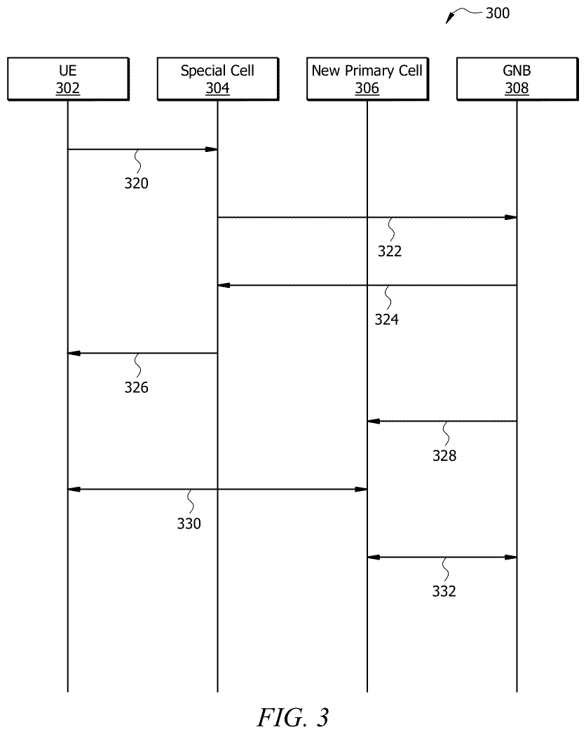

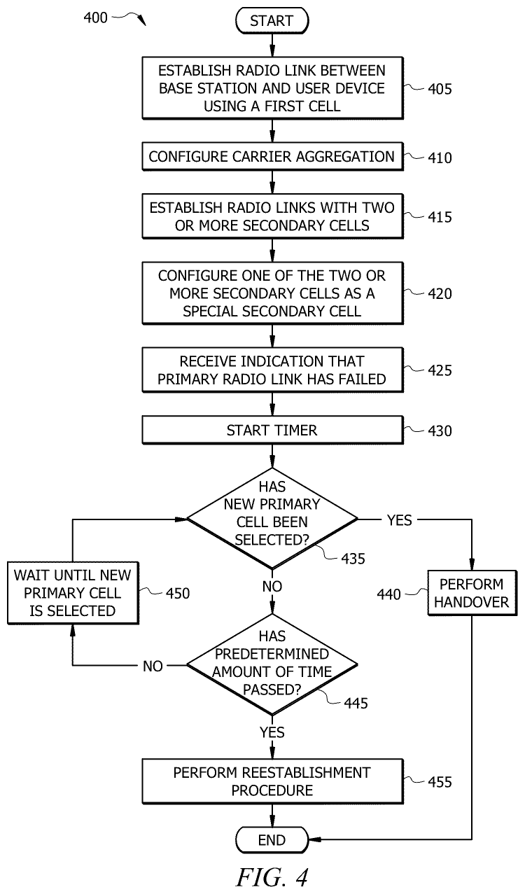

In one or more embodiments of the disclosure, one of the SCells, e.g., 116A, may be configured as an SPSCell. This SPSCell, e.g., 116A, is configured to additionally provide RRC with the UE 120. Typically, when the PCell 112 is in RLF, the secondary cells, e.g., 116A-116N, are not able to maintain a radio link with the UE 120. By having the SPSCell, e.g., 116A, the link may be maintained as described below regarding the signaling and methods described in FIGS. 3 and 4. When the PCell 112 is in RLF, the SPSCell maintains the link and receives a FailureInformation message from the UE 120; this FailureInformation may also include measurement on other cells, including other SCells, e.g., 116B-116N, and cells that are currently not involved in communicating data to the UE 120 but otherwise are able to communicate with the UE 120 such as cell 114. The base station 130 may determine that one of the cells, such as cell 114, may be able to serve as a new PCell, and the connection is handed over to the new PCell 114. The disclosure is not limited to a cell that is not currently communicating data, such as cell 114, and instead, the SPSCell, e.g., 116A or any of the other cells 116A-116N, may assume the role of being the new PCell from the previous PCell 112. Further, when the previous PCell 112 is no longer in RLF, it may resume that role, become a SCell, or be idle relative to the UE 120.

The disclosure is not limited to the specific number or arrangement of the cells shown in FIGS. 1A and 1B, and the illustration is simply for explanation. Additionally, while shown as being in different positions relative to the UE 120 and/or base station 130, all of the cells, e.g., 112, 114, and 116A-116N, may be co-located with the based station 130 or some or all of the cells, e.g., 112, 114, and 116A-116N may be located at a different location.

FIGS. 1A and 1B illustrate a particular arrangement of system 100, which performs PCell radio link failure fast recovery. Furthermore, FIGS. 1A and 1B describe and illustrate particular components, devices, or systems carrying out particular actions; this disclosure contemplates any suitable combination of any suitable components, devices, or systems carrying out any suitable actions.

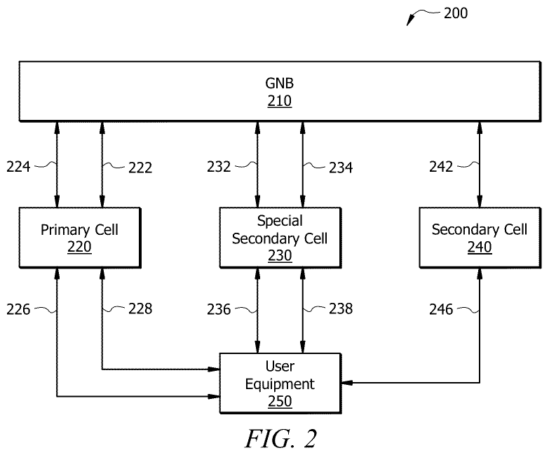

FIG. 2 illustrates a particular arrangement of system 200, which performs PCell radio link failure fast recovery. FIG. 2 shows the communication channels between the GNB 210, a PCell 220, a SPSCell 230, and a SCell 240 and their communication with a UE 250 in accordance with one or more embodiments. Each of these components may take the form of the components described above with regards to FIGS. 1A and 1B or any of the components or all of the components described in FIG. 2 may be different than those shown in FIGS. 1A and 1B. GNB 210 may be the same or a different device than that shown in FIG. 1B as base station 130. While indicated as a GNB, GNB 210 is not limited to being a GNB and may be any type of base station able to perform carrier aggregation. Similarly, the UE 250, PCell 220, SPSCell 230, and SCell 240 may correspond to the equivalent parts shown and described above with respect to FIGS. 1A and 1B. System 200 may include more or less components than shown in FIG. 2, and the disclosure is not limited to a single PCell 220, SPSCell 230, and SCell 240, as shown. For example, there may be five, eight, ten, twenty, or more SCells 240 in any particular system 200.

In one or more embodiments, GNB 210 communicates with the PCell 220. The communication includes a user data connection 222 and a RRC connection 224. These connections, e.g., 222 and 224, may be physical connections or may be transmitted over a radio link. These connections, e.g., 222 and 224, may transmit user data, control messages, control data, and other types of data and messages. Other connections may be established between the GNB 210 and the PCell 220 without departing from the disclosure, and the disclosure is not limited to just the user data connection 222 and RRC connection 224.

The PCell 220 receives the user data over user data connection 222 and control messages over RRC connection 224, and the PCell 220 forwards the user data and receives control messages over a radio link using user data connections 226 and RRC connection 228 with the UE 250. Similarly, the PCell 220 may receive uploaded user data from the UE 250 using user data connection 226 and control messages or status messages over RRC connection 228. The PCell 220 forwards the user data and receives control messages or status messages using data connections 222 and RRC connection 224 to the GNB 210.

Similarly, the SPSCell 230 includes a user data connection 232 and maintains a secondary or backup RRC connection 234 with the GNB 210. The SPSCell 230 also consists of a user data connection 236 for transmitting and receiving user data to and from the UE 250 and also provides an RRC connection 238 with the UE 250 for use at least when the PCell 220 is in RLF. Other SCells 240 only include a user data connection 242 between the GNB 210 and SCell 240 and a user data connection 246 with the UE 250. Both the SPSCell 230 and SCell 240 may include more or less connections than shown without departing from the disclosure.

User data connections 222, 226, 232, 236, 242, and 246 may allow for both upload and download or may be configured to only allow for download or only allow for upload between a particular cell and the UE 250. User data connections 222, 226, 232, 236, 242, and 246 allow data to be sent between the UE 250 and the backend of the GNB 210. In one or more embodiments, user data connections 222, 226, 232, 236, 242, and 246 may include downlink channels, such as, but not limited to, a physical downlink shared channel (PDSCH) or a physical broadcast channel PBCH to the UE 250 from the GNB 210. Similarly, for uploading data from the UE 250 to the GNB 210, user data connections 222, 226, 232, 236, 242, and 246 may include uplink channels, such as, but not limited to, a physical random access channel (PRACH) and a physical uplink shared channel (PUSCH). In some embodiments, an individual SCell, e.g., 240, may be configured to only provide a downlink channel, such as PDSCH to the UE 250 or an uplink channel PUSCH to the UE 250, where extra bandwidth is not needed in both directions.

The RRC connections 224 and 228 may comprise messages that may allow for connection establishment and release, as well as system information, gaging, and power control, among other things. In one or more embodiments, the RRC connections 224 and 228 may usc physical downlink control channels (PDCCH) and physical uplink control channels (PUCCH) to communicate control information between the GNB 210 and the UE 250. Only RRC connections 224 and 228 are used in one or more embodiments unless the UE 250 determines that the PCell is in RLF.

In one or more embodiments, when the UE 250 determines that the PCell 220 is in RLF, it may no longer be able to use RRC connections 224 and 228 to communicate with the GNB. At this point, the UE 250 uses RRC connections 238 and 234 to communicate with the GNB 210. The UE uploads through the PUCCH channel in RRC connections 238 and 234 a FailureInformation message, and the UE 250 and/or GNB 210 may begin a timer such as, but not limited to, a T316 timer. In one or more embodiments, this FailureInformation message includes measurements on all of the cells from which the UE 250 is currently able to receive a signal and make measurements. The GNB 210 uses these measurements and other criteria to determine a new PCell 220 for the UE 250 to communicate with. This may be the SPSCell 230, one or more SCells 240, or any other cell that the UE 250 is able to connect with. The identity of the new PCell 220 is transmitted through the PDCCH channel of RRC connections 234 and 238 to the UE 250 in the form of a RRCReconfiguration message, and the UE 250 begins using an RRC connection 224 and 228, as well as data connections 232 and 226 associated with the new PCell 220. The secondary cells 240 and SPSCell 230 remain the same unless one of them is the new PCell 22, in which case one or more other cells may be added to take the place of the new PCell 220 and/or the previous PCell 220 may be used if it is no-longer in RLF.

Furthermore, FIG. 2 describes and illustrates particular components, devices, or systems carrying out particular actions; this disclosure contemplates any suitable combination of any suitable components, devices, or systems carrying out any suitable actions.

FIG. 3 shows an example of signaling 300 between a UE 302, an SPSCell 304, a new primary cell 306, and GNB 308 when RLF occurs with a previous PCell. Each of these components may take the form of the components described above with regards to FIGS. 1A, 1B, and 2, or any of the components or all of the components described in FIG. 3 may be different than those shown in FIGS. 1A, 1B, and 2. GNB 308 may be the same or a different device than that shown in FIG. 1B as base station 130. Although shown as a GNB, GNB 308 may be any base station, e.g., 130, FIG. 1B that is able to perform carrier aggregation. Similarly, the UE 302, SPSCell 304, and new PCell 306 may correspond to the equivalent parts shown and described in FIGS. 1A, 1B, and 2. Signaling 300 may be performed between more or fewer components than shown in FIG. 2.

Initially, UE 302 sends a message 320 to the SPSCell 304, indicating that the previous PCell is in RLF. In one or more embodiments, this may be in the form of a FailureInformation message 320, which is defined in 3GPP TS 38.331, clause 6.2.2.2. In one or more embodiments, the FailureInformation message is modified from that in 3GPP TS 38.331, clause 6.2.2.2, to include additional measurement information. The FailureInformation message 320 may take the following form:

-- ASN1START
-- TAG-FAILUREINFORMATION-START

| | |
|---|---|
| FailureInformation ::= | SEQUENCE { |
| criticalExtensions | CHOICE { |
| failureInformation | FailureInformation-IEs, |
| criticalExtensionsFuture | SEQUENCE { } |

}
}

| FailureInformation-IEs ::= | SEQUENCE { | |
|---|---|---|
| failureInfoRLC-Bearer | FailureInfoRLC-Bearer | OPTIONAL, |
| lateNonCriticalExtension | OCTET STRING | OPTIONAL, |

| | |
|---|---|
| nonCriticalExtension | FailureInformation-v1610-IEs OPTIONAL |

}

| | |
|---|---|
| FailureInfoRLC-Bearer ::= | SEQUENCE { |
| cellGroupId | CellGroupId, |
| logicalChannelIdentity | LogicalChannelIdentity, |
| failureType | ENUMERATED {rlc-failure, spare3, spare2, spare1} |

}
FailureInformation-v1610-IEs ::= SEQUENCE {

| | | |
|---|---|---|
| failureInfoDAPS-r16 | FailureInfoDAPS-r16 | OPTIONAL, |
| nonCriticalExtension | SEQUENCE { } | OPTIONAL |

}

| | |
|---|---|
| FailureInfoDAPS-r16 ::= | SEQUENCE { |
| failureType-r16 | ENUMERATED {daps-failure, spare3, spare2, spare1} |

}

| | |
|---|---|
| measResultNeighCells | CHOICE { |
| measResultListNR | MeasResultListNR, |

}
-- TAG-FAILUREINFORMATION-STOP
-- ASN1STOP

The FailureInformation message 320 may take a different form than that shown above, and the message 320, as shown above, is only provided as an example.

Returning to FIG. 3, the SPSCell 304 receives the FailureInformation message 320 and forwards it as message 322 to the GNB 308 over an RRC connection. When the GNB 308 receives message 322, it begins to determine a new PCell based on the measResultNeighCells included in the FailureInformation messages 320 and 322 received by the GNB 308. Alternatively, the GNB 308 may use other information obtained from other sources to determine which new PCell 306 to use.

Once the GNB 308 determines a new PCell 306 to use, the GNB 308 may then communicate a RRCReconfiguration message 324 through the SPSCell 304 with message 326 to the UE 302. The RRCReconfiguration message 324 may take the form outlined in 3GPP 38.331 section 5.3.5.5. The RRCReconfiguration message 324 may take any other form without departing from the disclosure. The RRCReconfiguration message 324 instructs the UE 302 to begin communicating any RRC messages with the New PCell 306. At the same time, or alternatively, either before or after the RRCReconfiguration messages 324 and 326 are sent to the UE 302, the GNB 308 establishes an RRC connection with the new PCell 306 with messages 328. Message 328 allows the new PCell to assume the duties of the previous PCell.

New PCell 306 then begins to perform upload and download communications 330 with the UE. These communications are forwarded by the New PCell 306 to the GNB 308. Other secondary cells, as well as the SPSCell 304, may continue to function as they did before RLF, or they may have been assigned new rules, such as, for example, the SPSCell 304 being assigned the role of a New PCell 306.

As described above, the signaling 300 shown in FIG. 3 is exemplary, and the disclosure is not limited to the specific components and signals described. The signaling 300 may involve more or fewer cells than shown and may or may not be performed using a GNB.

FIG. 4 illustrates an example of method 400 for performing PCell radio link failure fast recovery. In one or more embodiments, method 400 is performed by the base station 130, as shown and described above with regards to FIG. 1B. In certain embodiments, method 400 may be performed by any of the components of system 100 and is not limited to being performed by the base station 130. Method 400 is not limited to being performed by the system shown in FIGS. 1A, 1B, and 2 or with the messages and/or signaling as described above with regards to FIG. 3.

Method 400 begins at operation 405. In operation 405, a radio link is established between a GNB and a UE using a first cell. The GNB or base station may coordinate the establishment of the connection by transmitting and receiving various control messages between the GNB and the UE using the first cell or another cell specifically configured for establishing connections. Alternatively, a radio link may be pre-existing between a UE and a GNB or other base station, and there is no need to establish one using a first cell.

Once a radio link is established between the UE and the GNB in operation 405, or if a radio link has already been established, the method 400 proceeds to operation 410. In operation 410, the GNB determines that carrier aggregation is needed and configures carrier aggregation. As described above, carrier aggregation improves the data rate for transferring data between the UE and GNB using multiple carriers and/or cells. The first cell is configured as a primary cell or PCell and provides the RLC connection with the UE. The RLC connection may use, in one or more embodiments, PDCCH for downlink control and PUCCH for uplink control.

Once carrier aggregation is established in operation 410, radio links are established between the GNB and at least two or more SCells in operation 415. These radio links are configured as secondary radio links in one or more embodiments and may not include RRC connections or signaling. In one or more embodiments, the secondary cells are configured to provide at least one data downlink and/or data uplink between the UE and GNB. These links may take the form of PDSCH and PBCH for downlink and PRACH and PUSCH for uplink. However, the disclosure is not limited to these specific forms, and the uplink and downlink radio links may take any form without departing from the disclosure.

Once a primary radio link is established with the first cell or PCell in operation 405 and a secondary radio link established with each of two or more other cells or SCells in operation 415, the method 400 proceeds to operation 420. In operation 420, at least one of the two or more SCells is configured as an SPSCell. The at least one SCell must be able to perform RRC signaling with the UE. The SCell configured as the SPSCell establishes a secondary or backup RLC connection with the UE. This secondary RRC may remain idle while the PCell maintains the primary radio link with the UE. Alternatively, both the secondary RRC and primary RRC may be active and transmit control information to and from the UE to the GNB.

Sometime after operation 420 is completed, the GNB may receive an indication from the UE through the SPSCell that RLF has occurred with the PCell. This may be because interference has occurred between the PCell and the UE on the specific bands or channels that the PCell is using or because of a physical change, such as the UE moving out of the range of the particular PCell. When the UE transmits the RLF in operation 425 or immediately after, in one or more embodiments, the UE in operation 430 starts a timer. Alternatively, the timer may be started in the GNB or the secondary cell in one or more embodiments. The timer in one or more embodiments may take the form of a T316 timer; however, it may take any form without departing from the disclosure.

Once the timer is started in operation 430, the method 400 proceeds to operation 435. In operation 435, a determination is made if the GNB has selected a new PCell. If the new PCell has been selected, method 400 proceeds to operation 440, where handover is performed, and the new PCell begins providing the RRC communications to the UE. The handover may be performed after the UE receives an RRCReconfiguration message as described above concerning FIG. 3.

However, in operation 435, if it is determined that the new PCell has not been selected, method 400 proceeds to operation 445. This may occur in one or more embodiments if the UE has not received the RRCReconfiguration message. In operation 445, the timer established in operation 430 is checked. If the timer indicates that the amount of time that has passed since UE or other components of the system have indicated an RLF is greater than a predetermined amount of time, or the time expires when the timer reaches a predetermined time without a handover being performed. In that case, the method proceeds to operation 445, and a reestablishment procedure operation 455 is performed; otherwise, the UE or other component proceeds to operation 450, and operations 435-450 are performed until either a handover operation 440 is performed or the timer expires and reestablishment procedure operation 455 is performed.

The predetermined time may be any amount of time determined by the operators of the GNB or a user or manufacturer of the UE. In one or more embodiments, this predetermined time may be a time period such as 50 msec, 200 msec, 400 msec, 1000 msec, 2000 msec, or any other time period or combination that is deemed to be enough time for handover operation 440 to be performed without causing undo latency or delay that may be noticeable to a user of the UE.

Returning to FIG. 4, if a primary cell is selected in operation 435, a handover is performed in operation 440. This comprises, in one or more embodiments, sending an RRCReconfiguration message to the UE through the SPSCell. Once the UE receives this message, the GNB along with the UE, may perform the handover to a new PCell. As discussed previously, the new PCell may be one of the SCells, the SPSCell, or any other cells connected to the GNB that are able to provide an RRC connection as well as data to the UE. After the handover occurs in operation 440, method 400 may end.

If, however, the time expires, the method 400 proceeds to operation 455, where a reestablishment procedure is performed. In the reestablishment procedure, the UE loses the current radio links, including the secondary links with the SCells, and the method either ends or begins again at operation 405. As previously discussed, when the reestablishment procedure is performed, any cached data at the individual cells may be purged and this may result in noticeable delay or latency at the UE.

The method may then end after either operation 455 or operation 440. This disclosure describes and illustrates the particular steps of method 400 in FIG. 4 as occurring in a particular order; this disclosure contemplates any suitable operations of method 400 of FIG. 4 occurring in any suitable order.

Although this disclosure describes and illustrates an example method for performing PCell radio link failure fast recovery using the particular operations of the method of FIG. 4, this disclosure contemplates any suitable method for performing PCell radio link failure fast recovery, which may include all, some, or none of the steps of the method of FIG. 4, where appropriate. Although FIG. 4 describes and illustrates particular components, devices, or systems carrying out particular actions. This disclosure contemplates any suitable combination of any suitable components, devices, or systems carrying out any suitable actions.

FIG. 5 shows an example of computer architecture for a computational device 500 capable of executing program components to implement the abovementioned functionality. The computer architecture shown in FIG. 5 illustrates any type of computational device 500, such as a base station or GNB, radio network controller, a switch, router, wireless controller, conventional server computer, workstation, desktop computer, laptop, tablet, network appliance, e-reader, smartphone, or other computing device. It may be utilized to execute any of the software components presented herein. In some examples, the computational device 500 may correspond to any of the devices, such as the UE 120 and base station 130, as shown in FIGS. 1A and 1B, and/or any other device described therein, as well as with regards to FIG. 2 or 3. The computational device 500 may comprise personal devices (e.g., smartphones, tablets, wearable devices, and laptop devices), networked devices, such as servers, switches, routers, hubs, bridges, gateways, modems, repeaters, access points, and/or any other type of computing device that may be running any type of software and/or virtualization technology.

In particular embodiments, one or more computational devices 500 perform one or more steps of one or more methods described or illustrated herein, such as the methods described with respect to FIG. 4. In particular embodiments, one or more computational devices 500 provide the functionality described or illustrated herein, such as the functionality described with respect to FIGS. 1A, 1B, 2, and 3. In particular embodiments, software running on one or computational device 500 performs one or more steps of one or more methods described or illustrated herein or provides functionality described or illustrated herein. Particular embodiments include one or more portions of one or more computational devices 500.

Particular embodiments may include any suitable number of computational devices 500. Computational device 500 may take any suitable physical form. As an example, and not by way of limitation, computational device 500 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computational device 500 may include one or more computational devices 500; be unitary or distributed; span multiple locations; span multiple machines; span multiple data centers; or reside in a cloud, which may include one or more cloud components in one or more networks.

Where appropriate, one or more computational devices 500 may perform without substantial spatial or temporal limitation one or more steps of one or more methods described or illustrated herein. As an example, and not by way of limitation, one or more computational devices 500 may perform in real-time or in batch mode one or more steps of one or more methods described or illustrated herein. One or more computational devices 500 may perform at different times or at other locations one or more steps of one or more methods described or illustrated herein, where appropriate.

In particular embodiments, computational device 500 includes a processor 502, memory 504, storage 506, an input/output (I/O) interface 508, a communication interface 510, and a bus 512. Although this disclosure describes and illustrates a particular computational device or node having a particular number of particular components in a particular arrangement, particular embodiments may include any suitable computer system having any suitable number of any suitable components in any suitable arrangement.

In particular embodiments, processor 502 includes hardware for executing instructions, such as those making up a computer program. As an example, and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. Processor 502 may include any number of suitable internal caches, where appropriate.

As an example, and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual address translation for processor 502.

In particular embodiments, processor 502 may include one or more internal registers for data, instructions, or addresses. Processor 502 may include any suitable number of any suitable internal registers, where appropriate. Where appropriate, processor 502 may include one or more arithmetic logic units (ALUs), be a multi-core processor, or include one or more processors 502. Although this disclosure describes and illustrates a particular processor, particular embodiments may include any suitable processor.

In particular embodiments, memory 504 includes main memory for storing instructions for processor 502 to execute or data for processor 502 to operate on. As an example, and not by way of limitation, computational device 500 may load instructions from storage 506 or another source (such as, for example, another computational device 500) to memory 504. Processor 502 may then load the instructions from memory 504 to an internal register or internal cache.

To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere).

One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate access to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where applicable, this RAM may be single-ported or multi-ported RAM. Particular embodiments may include any suitable RAM. Memory 504 may include one or more memories 504, where appropriate. Although this disclosure describes and illustrates a particular memory, particular embodiments may include any suitable memory.

In particular embodiments, storage 506 includes mass storage for data or instructions. As an example, and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Where appropriate, storage 506 may be internal or external to the computational device 500. In particular embodiments, storage 506 is a non-volatile, solid-state memory. In particular embodiments, storage 506 includes read-only memory (ROM). Where applicable, this ROM may be mask-programmed ROM, programmable ROM (PROM), erasable PROM (EPROM), electrically erasable PROM (EEPROM), electrically alterable ROM (EAROM), flash memory, or a combination of two or more of these. Storage 506 may take any suitable physical form.

Storage 506 may include one or more storage control units facilitating communication between processor 502 and storage 506, where appropriate. Where appropriate, storage 506 may include one or more storages 506. Although this disclosure describes and illustrates particular storage, particular embodiments may include any suitable storage.

In particular embodiments, I/O interface 508 includes hardware, software, or both, providing one or more interfaces for communication between a computational device 500 and one or more I/O devices. Computational device 500 may include one or more of these I/O devices, where appropriate. One or more of these I/O devices may enable communication between a person and computational device 500. As an example, and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. Particular embodiments may include any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, specific embodiments may include any suitable I/O interface. In particular embodiments, I/O interface 508 may include an interface to a remote network management system.

In particular embodiments, communication interface 510 includes hardware, software, or both providing one or more interfaces for communication (such as, for example, packet-based communication) between computational device 500 and one or more other computational devices 500 or one or more networks. As an example, and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network.

Particular embodiments may include any suitable network and any suitable communication interface 510 for it. As an example, and not by way of limitation, computational device 500 may communicate with an ad hoc network, a personal area network (PAN), a LAN, WAN, MAN, or one or more portions of the Internet or a combination of two or more of these. One or more portions of one or more of these networks may be wired or wireless. As an example, computational device 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computational device 500 may include any suitable communication interface 510 for any of these networks, where appropriate. Communication interface 510 may include one or more communication interfaces 510, where applicable. Although this disclosure describes and illustrates a particular communication interface, particular embodiments may include any suitable communication interface.

In particular embodiments, bus 512 includes hardware, software, or both coupling components of the computational device 500 to each other. As an example, and not by way of limitation, bus 512 may include an Accelerated Graphics Port (AGP) or other graphics bus, an Enhanced Industry Standard Architecture (EISA) bus, a front-side bus (FSB), an HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIc) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, particular embodiments may include any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable, non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

While the disclosure is described with respect to the specific examples, it is to be understood that the scope of the disclosure is not limited to these specific examples. Since other modifications and changes varied to fit particular operating requirements and environments will be apparent to those skilled in the art, the disclosure is not considered limited to the example chosen for purposes of disclosure and covers changes and modifications that do not constitute departures from the true spirit and scope of this disclosure.

Although the application describes embodiments having specific structural features and/or methodological acts, it is to be understood that the claims are not necessarily limited to the specific features or acts described. Instead, the specific features and acts are merely illustrative of some embodiments that fall within the scope of the application's claims.

What is claimed is:

1. A computer-implemented method, comprising:
establishing a first radio link between a first cell and a user device;
configuring the first cell as a primary cell and the first radio link as a primary radio link;
establishing a secondary radio link with each of two or more secondary cells selected from a plurality of additional cells that are able to communicate with the user device;
selecting and configuring a second cell of the two or more secondary cells to be a special secondary cell;
receiving an indication that the primary radio link has failed, wherein the indication is received by the special secondary cell;
sending a reconfiguration message to the user device through the special secondary cell; and
performing a handover of the primary radio link from the first cell to a new primary cell selected from one of the plurality of additional cells that are able to communicate with the user device.

2. The computer-implemented method of claim 1, wherein the new primary cell is selected from the two or more secondary cells.

3. The computer-implemented method of claim 1, wherein the new primary cell is the special secondary cell.

4. The computer-implemented method of claim 1, further comprising after receiving the indication, a timer is started to determine an amount of time that passes before performing the handover, wherein when the timer reaches a predetermined time without a handover being performed, a reestablishment procedure is initiated.

5. The computer-implemented method of claim 1, wherein both the primary cell and the special secondary cell provide a radio resource control (RRC) connection with the user device.

6. The computer-implemented method of claim 1, wherein at least the first cell and the new primary cell are fifth-generation (5G) cells.

7. The computer-implemented method of claim 1, wherein at least the first cell is a fifth-generation (5G) cell, and the new primary cell is one of an evolved universal terrestrial radio access (EUTRA) cell or a universal terrestrial radio access (UTRA) cell.

8. The computer-implemented method of claim 1, wherein the indication includes measurement information for the plurality of additional cells that are able to communicate with the user device.

9. A base station, comprising:
one or more processors; and
one or more computer-readable non-transitory storage media coupled to the one or more processors that stores instructions operable when executed by the one or more processors to cause the base station to perform operations comprising:
establishing a first radio link between a first cell of a plurality of cells and a user device;
configuring the first cell as a primary cell and the first radio link as a primary radio link;
establishing a secondary radio link with each of two or more secondary cells selected from a plurality of additional cells that are able to communicate with the user device;
selecting and configuring a second cell of the two or more secondary cells to be a special secondary cell;
receiving an indication that the primary radio link has failed, wherein the indication is received by the special secondary cell;
sending a reconfiguration message to the user device through the special secondary cell; and
performing a handover of the primary radio link from the first cell to a new primary cell selected from one of the plurality of additional cells that are able to communicate with the user device.

10. The base station of claim 9, wherein the new primary cell is selected from the two or more secondary cells.

11. The base station of claim 9, wherein the new primary cell is the special secondary cell.

12. The base station of claim 9, wherein both the primary cell and the special secondary cell provide a radio resource control (RRC) connection with the user device.

13. The base station of claim 9, wherein at least the first cell and the special secondary cell is a fifth generation (5G) cell.

14. The base station of claim 13, wherein the new primary cell is an evolved universal terrestrial radio access (EUTRA) cell or a universal terrestrial radio access UTRA cell.

15. The base station of claim 13, wherein the new primary cell is a 5G cell.

16. The base station of claim 9, wherein the indication includes measurement information for the plurality of cells that are able to communicate with the user device.

17. One or more computer-readable non-transitory storage media embodying instructions that, when executed by a processor, cause the processor to perform operations comprising:
establishing a first radio link between a first cell and a user device;
configuring the first cell as a primary cell and the first radio link as a primary radio link;
establishing a secondary radio link with each of two or more secondary cells selected from a plurality of additional cells that are able to communicate with the user device;
selecting and configuring a second cell of the two or more secondary cells to be a special secondary cell;
receiving an indication that the primary radio link has failed, wherein the indication is received by the special secondary cell;
sending a reconfiguration message to the user device through the special secondary cell; and
performing a handover of the primary radio link from the first cell to a new primary cell selected from one of the plurality of additional cells that are able to communicate with the user device.

18. The one or more computer-readable non-transitory storage media of claim 17, wherein the indication includes measurement information for the plurality of additional cells that are able to communicate with the user device.

19. The one or more computer-readable non-transitory storage media of claim 17, wherein the operations further comprise:
starting a timer after receiving the indication to determine an amount of time that passes before the handover is performed, wherein when the timer reaches a predetermined time without a handover being performed, a reestablishment procedure is initiated.

20. The one or more computer-readable non-transitory storage media of claim 17, wherein both the primary cell and the special secondary cell provide a radio resource control (RRC) connection with the user device.
